(19) United States
(12) Patent Application Publication
(10) Pub. No.: US 2008/0271379 A1
(43) Pub. Date: Nov. 6, 2008

(54) Motor Vehicle Door with a Side Window Pane

(76) Inventors: Dalibor Rietdijk, Wetzlar (DE); Reinhard Peis, Zolling (DE)

Correspondence Address: CHRISTIE, PARKER & HALE, LLP, PO BOX 7068, PASADENA, CA, 91109-7068, US

(21) Appl. No.: 11/579,478

(22) PCT Filed: Apr. 19, 2005
(86) PCT No.: PCT/DE2005/000743

§ 371 Date: Jan. 30, 2008

(30) Foreign Application Priority Data
May 3, 2004 (DE) 20 2004 007 053.7

(51) Int. Cl. E06B 3/32; B60J 1/17

(52) U.S. Cl. 49/142; 296/146.2

(57) ABSTRACT

A motor vehicle door with a side window includes a window winder associated with the side window to lower the side window in the door body. The side window is of split design and a separate window winder is associated with each window part that is configured to completely lower the window part in the door body.

### CROSS-REFERENCE TO A RELATED APPLICATION

This application is a National Phase Patent Application International Patent Application Number PCT/DE2005/000743, filed on Apr. 19, 2005, which claims priority of German Patent Application Number 20 2004 007 053.7, filed on May 3, 2004.

### BACKGROUND

The invention relates to a motor vehicle door with a side window.

A motor vehicle door with a side window which may be raised and lowered and a front, fixed side window is known from EP 1 201 862 A1. A cable window winder is arranged in the door body, by means of which the side window may be completely lowered into the door body. No window winder is associated with the front window part, so that said window part may not be lowered.

In such a window winder system, the window is only able to be completely lowered when the door body has a minimum size. Even with sports cars or convertibles, the door bodies are, however, often small, so that the window is not able to be completely lowered.

Doors are also known in which the window region is releasably attached to the door body and, if required, able to be removed manually and carried in the vehicle. This, however, requires manipulation, and carrying the window parts restricts the available luggage space.

### SUMMARY

It is the object of the present invention to develop a motor vehicle door, such that without additional manual handling, the side window is able to be completely lowered.

It is provided according to the invention that the window is of split design and in that a separate window winder is associated with each window part, by means of which the respective window part may be completely lowered in the door body. The window is preferably split into two parts, the split being created according to a desired design by a line extending substantially horizontally or vertically.

With a vertical window split, according to an embodiment of the invention, it may be provided that at least one of the window parts is pivoted about a pivot point into the door body. The window part or the further window parts are subsequently—or simultaneously/in a phase-shifted manner—also lowered into the door body by means of a window winder carrying out a pivoting movement.

With a horizontal window separation, according to a preferred embodiment of the invention, window winders comprising slide and/or guide rails are used. The window winder associated with the lower window part cooperates with the lower edge of this window, the winder cooperating with the upper window grips said upper window on the outer regions of the window lower edge and/or in a side region, which is enclosed by a window guide located above the door body. The guide rails and/or tracks of the window winders are designed, therefore, such that the window parts are lowered into the door body through a single slot arranged on the upper edge of the door body and are located parallel and adjacent to one another in the door body itself.

In this embodiment of the invention, firstly the lower window part is lowered and completely moved into the door body. Subsequently, the window winder associated with the upper window part is activated, which then moves this window into the door body. To optimize time, it may also be provided to start the winder drives simultaneously and/or in a phase-shifted manner, for example in order to lower the upper window while the lower window is still moving into the door body. Closing the window region is carried out in a similar manner. The window parts are moved out of the lowered position in the inside of the door body simultaneously or in a phase-shifted manner or consecutively.

The separating region of the two or more window parts may be located between the planes of the windows or in the impact region of the window edges. In the first case, the window parts in the closed state are located in two parallel planes and, for lowering, are moved and/or pivoted along predetermined paths. A seal in the impact region of the window edges requires that the window parts in the closed state form a surface. For lowering the window parts, the movement paths deflect one another so that the window parts are located adjacent to one another after being lowered in the door body. The lowering of the window parts is carried out by pivoting movements, thus the pivoting planes may be configured accordingly and/or at least one window part also carries out a movement perpendicular to the window surface, in addition to a pivoting movement.

Sealing of the window parts in the impact region thereof results in a separating line which does not greatly interfere with the visual range. In an embodiment of the invention, the seal extending along the separating line is an H-shaped profiled strip which is placed on one edge of the window. This strip, made from plastics material, is then either fixed to the lower edge of the upper window or to the upper edge of the lower window and is moved with the respective window. The opposing opening region of the H-strip serves as a centering region for the opposing window edge and sealingly receives said window edge during closing.

According to a further preferred embodiment of the invention, one window edge—for example the lower edge—is cut out in a concave manner and filled with a sealing material providing a convex contour. The edge of the upper window, for example, to be brought into contact with the sealing material also comprises a hollow cut-out so that the two window edges enclose the seal in the closed state. By the cooperation of the hollow cut-out and the convex upper face of the seal, a centering function for the window parts is also produced during the closing process.

Further embodiments of the window separating region are created with the use of composite glass windows, for example composite safety glass. One embodiment consists in that the central region and the region comprising the plastics film of the two window edges is cut out in a hollow manner and a seal with a convex upper face is inserted into one of the edges. As in the aforementioned embodiment, during the closing process centering of the window edges also takes place, in addition to the sealing function.

A further embodiment when using a composite glass window consists of step-shaped separating edges of the upper and lower windows. The sealing material is applied to the stepped separating region, for example of the lower window edge. When moving the two windows together, the window parts are also centered and, by means of the contact pressure when closing, the separating line is sealed.

The window split according to the invention allows the complete lowering of a window region which is large compared to the door body. When the door bodies are cut away deeply downwards, such as for example with roadsters, no awkward window parts remain above the door body. Additional manual handling is also dispensed with, so that when using motor-driven window winders comfortable operation results.

The window winders associated with the individual window parts are preferably motor-driven. In this connection, a separate drive motor may be associated with each window winder, so that the individual window parts—according to the kinematic conditions of the window guides—may be lowered and/or lifted simultaneously, in a phase-shifted manner or consecutively.

The individual window winders may also have a common drive motor. A motor acts simultaneously via a gear mechanism on two or more window winders which produces a simultaneous movement of the window parts. When using a corresponding gear mechanism it is also possible that the lifting and/or lowering of a window part is only triggered when a further window part has passed a specific position.

### BRIEF DESCRIPTION OF THE DRAWINGS

Furthermore, the description of embodiments of the invention is made with reference to the figures, in which:

FIG. 1 shows a vehicle door with two pivotable window parts in the closed state.

FIG. 2 shows a vehicle door with two pivotable window parts in the opened state.

FIGS. 3-5 show a vehicle door with a horizontal window split.

FIGS. 6-9 show sealing possibilities of the window separating point.

### DETAILED DESCRIPTION

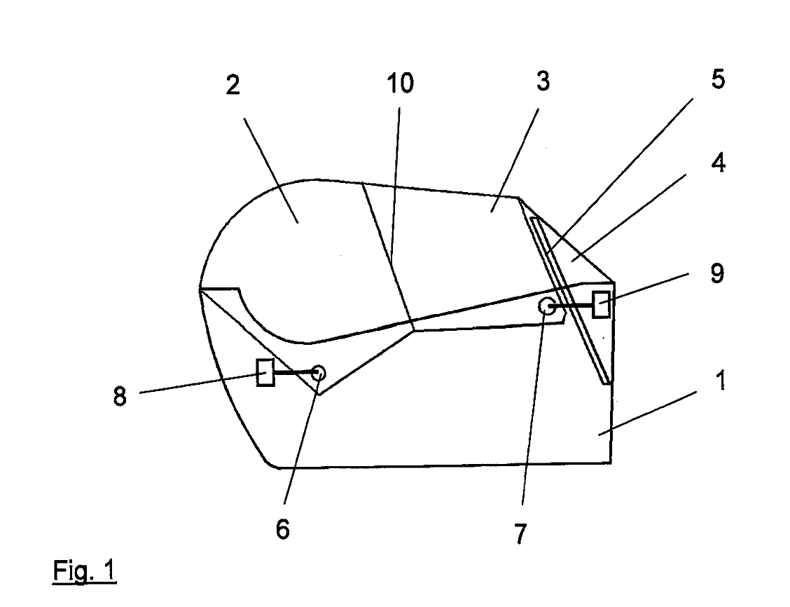

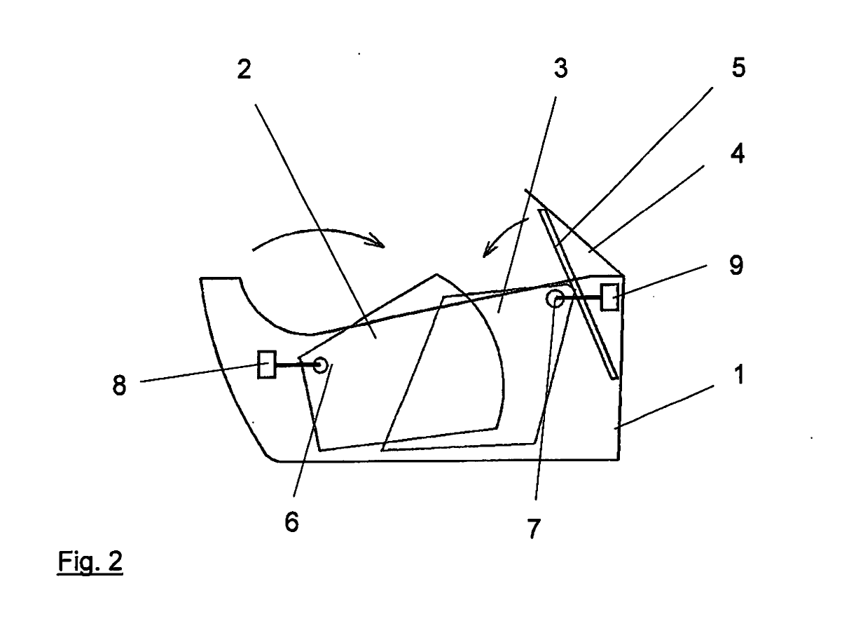

The vehicle door of FIGS. 1 and 2 consists of a door body 1, two window parts 2, 3, a triangular window 4 upstream of the window parts 2, 3 in the direction of travel and a strip 5, which is arranged between the window part 3 and the triangular window 4. One respective window winder 8, 9 comprising a drive motor and by means of which the window parts may be pivoted about the pivot axes 6, 7, is associated with the window parts 2, 3. In FIG. 1 the window region is closed and the window parts 2, 3 make contact in the separating region 10. FIG. 2 shows, by means of the arrows, how the window parts 2, 3 are pivoted into the door body 1. The window parts 2, 3 are therefore completely introduced into the door body so that the window part is no longer visible above the door upper edge 11.

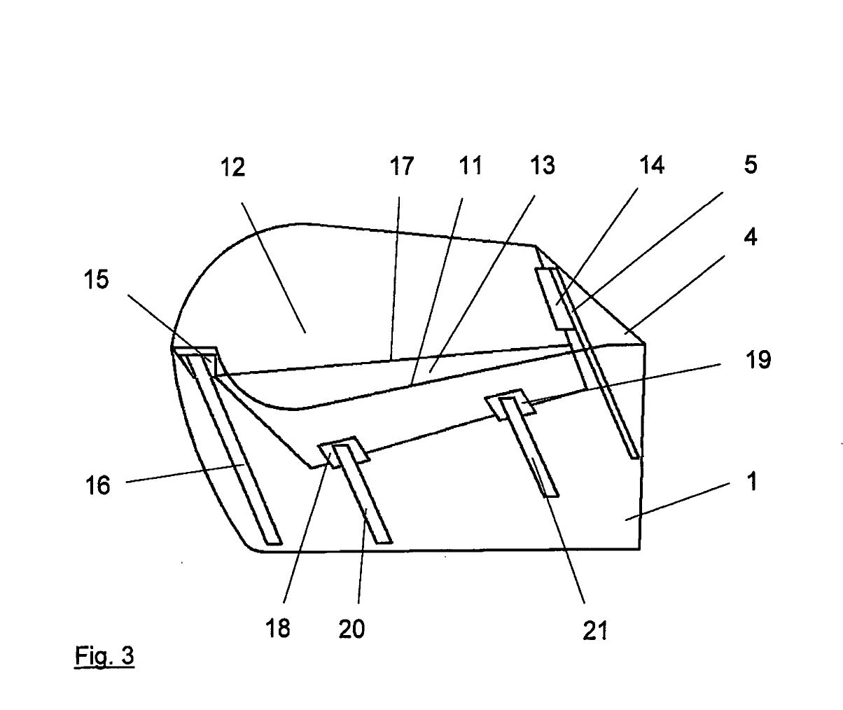

With the vehicle door according to FIG. 3, the window region is horizontally split, so that the window parts 12, 13 are located over one another. Two driving units 14, 15 are associated with the upper window part 12, which hold the upper window part 12 on the front edge thereof and/or in the rear region on the lower edge thereof. The driving units 14 and 15 are displaceably coupled to the strip 5 and/or a slide rail 16 arranged in the rear region of the door body 1 and thus form the window winder for the upper window part 12. The driving units 14, 15 are moved by drive means, not shown.

The lower window part 13 in contact in the separating region 17 with the upper window part 12 on the lower edge thereof, is received on its lower edge in driving units 18, 19, which are movably coupled to slide rails 20, 21. These driving units 18, 19 are also moved by drive means, not shown, and thus form the window winder for the lower window part 13.

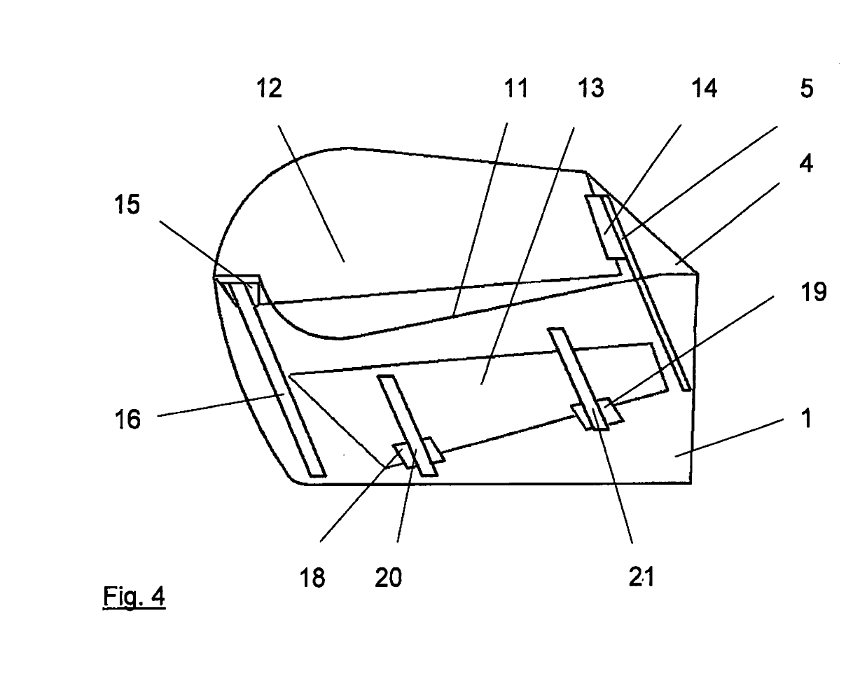

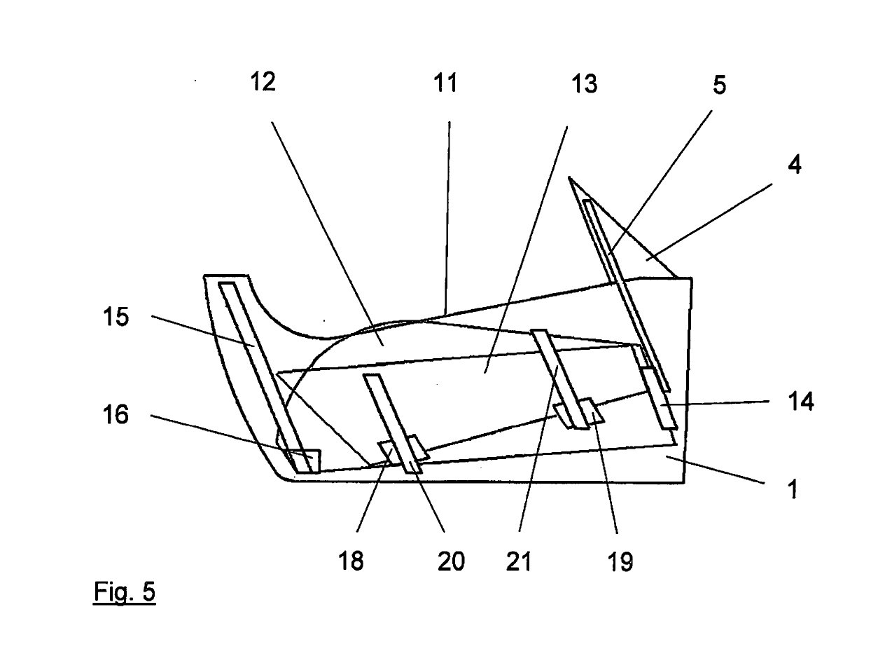

For lowering the window region, the lower window part 13 is firstly moved into the door body 1 (FIG. 4). A free space is thereby produced between the door upper edge 11 and the lower edge of the upper window part 12. Subsequently, the upper window part 12 is moved into the door body, so that now the entire region above the door body 1 is windowless (FIG. 5).

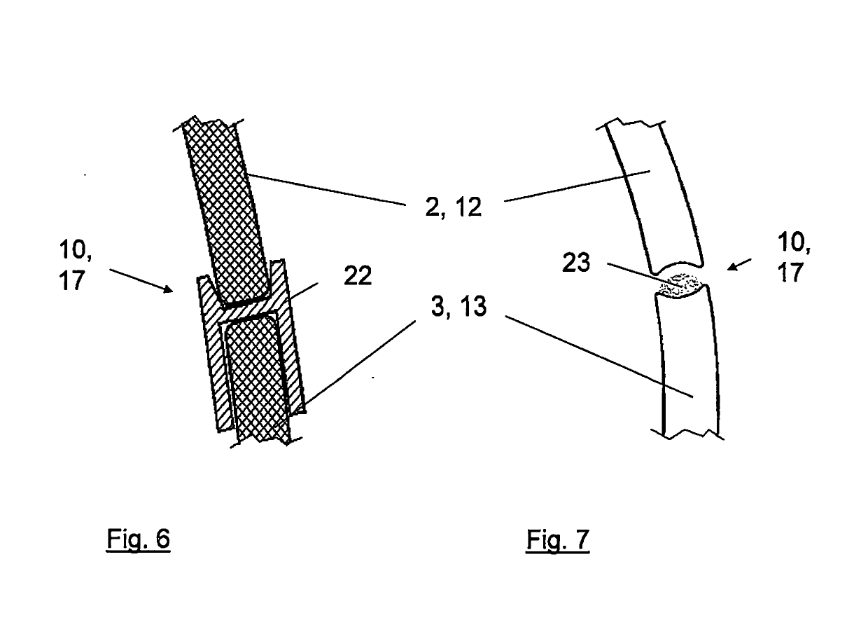

FIG. 6 shows a sealing arrangement for the separating region 10; 17 between two window parts 2; 12, 3; 13. The sealing strip 22 is configured as an H-shaped profiled strip which is placed on the edge of the window part 3; 13. The part of the seal facing the edge of the opposing window part 2; 12 comprises a V-shaped widened portion, by means of which the edge of the window part 2; 12 is centered when closing the window.

In the embodiment according to FIG. 7, the two edges of the window parts 2; 12, 3; 13 are cut out in a concave manner. A seal 23 is bonded into the one groove of the window part 3; 13 thus produced. This cooperates with the hollow cut-out edge of the window part 2; 12.

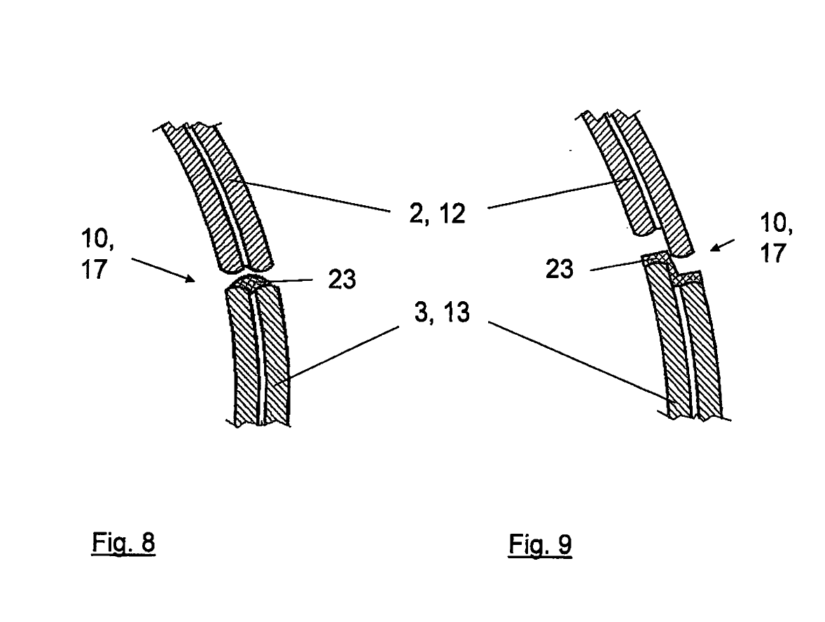

The window parts 2; 12, 3; 13 of the versions of FIGS. 8 and 9 consist of laminated composite glass in which a plastics film is arranged between two outer glass panes. In the version according to FIG. 8 the edges of the window parts 2; 12, 3; 13 are also of concave shape and one of the edges is laminated with a seal.

In the separating region according to FIG. 9, the edges of the window parts 2; 12, 3; 13 are of stepped design, so that the two stepped parts engage in one another and an overlap is created. The seal 23 is bonded to extend over the two stepped parts of the one window part 3; 13.

1-19. (canceled)

20. A motor vehicle door comprising:
a side window split into a plurality of window parts; and
a separate window winder associated with each window part and configured to completely lower the corresponding window part in the door body.

21. The motor vehicle door of claim 20, wherein the side window is split by a substantially horizontally extending separating region into an upper window part and a lower window part.

22. The motor vehicle door of claim 20, wherein the side window is subdivided into two adjacent window parts by a substantially vertically extending separating region.

23. The motor vehicle door of claim 20, wherein a window winder comprising a slide rail is associated with at least one of the window parts.

24. The motor vehicle door of claim 20, wherein a window winder pivoting the window about a pivot axis is associated with at least one of the window parts.

25. The motor vehicle door of claim 20, wherein a drive motor is associated with each of the window winders.

26. The motor vehicle door of claim 20, wherein a drive motor is associated with one of the window winders and at least another one of the window winders is coupled to the drive motor.

27. The motor vehicle door of claim 21, wherein at least one of the window winders is coupled to a lower edge of the lower window part.

28. The motor vehicle door of claim 21, wherein at least one of the window winders is coupled to a lateral edge region of the upper window part.

29. The motor vehicle door of claim 21, wherein at least one of the window winders is coupled to a lower edge in an edge region of the upper window part.

30. The motor vehicle door of claim 20, comprising a seal arranged in a separating region of two adjacent window parts.

31. The motor vehicle door of claim 30, wherein adjacent window parts overlap one another in an overlapping region and wherein the seal is arranged in the overlapping region.

32. The motor vehicle door of claim 30, wherein two adjacent window parts border one another with their edges and the seal is arranged between the edges.

33. The motor vehicle door of claim 32, wherein one of the edges is concave.

34. The motor vehicle door of claim 33, wherein the seal is inserted into the concave edge.

35. The motor vehicle door of claim 32, wherein the edges of the two adjacent window parts are configured as two steps, partially creating an overlap.

36. The motor vehicle door of claim 32, wherein the seal is configured as a profiled part placed on one of the edges.

37. The motor vehicle door of claim 36, wherein the seal is configured as an H-shaped profiled part.

38. The motor vehicle door of claim 20, wherein at least one of the window parts consists of laminated composite glass.
